(19) United States
(12) Patent Application Publication
(10) Pub. No.: US 2006/0254591 A1
(43) Pub. Date: Nov. 16, 2006

(54) Personal hygiene device and method

(76) Inventor: David Marx, Thornhill (CA)

Correspondence Address: BERESKIN AND PARR, 40 KING STREET WEST, BOX 401, TORONTO, ON, M5H 3Y2, CA

(21) Appl. No.: 11/172,895

(22) Filed: Jul. 5, 2005

Related U.S. Application Data
(63) Continuation-in-part of application No. 11/126,186, filed on May 11, 2005, now abandoned.

(51) Int. Cl. A62B 23/02; A62B 18/02; A62B 9/02

(52) U.S. Cl. 128/206.19; 128/206.18; 128/206.21; 128/206.28; 128/207.13; 128/206.17; 128/206.16; 128/206.14; 128/206.13; 128/206.12; 128/205.24; 128/205.28; 128/205.27; 128/205.25

(57) ABSTRACT

A method of preventing or limiting the spread of germs which involves providing a mask that can adopt an erected operative configuration and a compacted configuration in which the mask can be accommodated in a pocket or purse of a user. When released, the mask springs open to its erected configuration and can be placed over the mouth and nose of the wearer to prevent outward expulsion of material during a cough or sneeze. The mask includes an opening for releasing excess air from within the mask, the opening being closed by a filter. The filter is designed to retain inside the mask, germs normally expelled during a sneeze or cough.

### CROSS-REFERENCE TO RELATED APPLICATION

This application is a continuation-in-part of application Ser. No. 11/126,186 filed May 11, 2005.

### FIELD OF THE INVENTION

This invention relates to the prevention or limitation of the spread of germs by individuals who cough or sneeze.

### BACKGROUND OF THE INVENTION

A person who coughs or sneezes will often attempt to cover his or her mouth with a hand or possibly a tissue or handkerchief. At best, this may contain some of the droplets of saliva, mucus and the like that would otherwise be expelled into the surrounding air. While this may limit to some extent the spread of germs, it is obviously not an ideal solution. In fact, the problem may be exacerbated if the person uses a hand and does not immediately wash.

In times of public concern about the spread of disease, a few people may wear paper particle masks in an attempt to protect themselves. Such masks are awkward to put on and take off and unsightly in wear. The person typically will wear the mask continuously while in public. Further, a particle mask is designed to keep out particulate matter and protect the individual wearing the mask, rather than keep in germs and protect third parties.

An object of the present invention is to provide a personal hygiene device and method which address this problem.

### SUMMARY OF THE INVENTION

In one aspect, the invention provides a method of preventing or limiting the spread of germs which involves providing for wear by an individual, a mask comprising a structure that can adopt an erected, operative configuration and a compacted configuration in which the mask can be accommodated in, for example, a pocket or purse. The structure has a memory that tends to return the structure to its erected configuration when unrestrained. In that configuration, the structure is shaped to cover the mouth and nose of a wearer. The structure is impervious to outward expulsion of material from the mouth and/or nose of a user in sneezing or coughing, while including an opening that is closed by a filter for allowing release of excess air from a sneeze or cough. The method involves normally retaining the mask in its compacted configuration out of sight, releasing the mask to allow it to adopt its erected configuration when a sneeze or cough is anticipated by a user, and holding the mask over the mouth and nose of the user during sneezing or coughing.

The invention also provides a personal hygiene device comprising a mask as defined previously.

In summary, the mask will normally be kept in a person's pocket or purse in its compacted configuration and will be withdrawn, allowing the mask to open to its erected configuration when the user feels a sneeze or cough coming on. The mask is then placed over the nose and mouth. The impervious structure contains any material that is expelled from the nose and/or mouth of the wearer when the sneeze or cough actually occurs, while allowing excess air to be released through the filter.

A structure having the required characteristics can be achieved in many different ways. Preferably, however, the structure includes a plastic moulded core or base. The structure may be thermally formed from an extruded sheet film in the erected, operative configuration. Such a structure is crushable so that the mass can be compacted for placing in the pocket or purse. At the same time, the structure has a memory and will return to the erected, operative configuration when unrestrained. A paper or other absorbent lining preferably will be provided on the interior of the plastic core or base.

While various plastic materials may be used, a polypropylene or polypropylene-based material may be preferred. For example, the material may comprise polypropylene compounded with rubber or a rubber-like material to improve flexibility and fracture resistance.

In a preferred embodiment, the structure is contoured to fit over the nose and mouth of the wearer and has, around its perimeter, an outwardly directed lip that may be curved in cross-section so as to provide a sealing surface for contact with the wearer's face.

### BRIEF DESCRIPTION OF THE DRAWINGS

In order that the invention may be more clearly understood, reference will now be made to the accompanying drawings which illustrate a particular preferred embodiment of the invention by way of example, and in which:

FIG. 1 is a perspective view showing a mask in accordance with a preferred embodiment of the invention, held in its compacted configuration;

FIG. 2 is a perspective view showing the mask from the inside, having been released for return to its normal erected configuration;

FIG. 3 shows the mask held in place on the face of a user;

FIG. 4 shows the mask as seen from the side and partly broken away;

FIG. 5 is a view similar to FIG. 4 showing the complete structure of the mask in cross-section; and,

FIG. 6 comprises views denoted (a) and (b) which show, respectively, an exploded view and an assembled view of the filter area of the mask.

### DETAILED DESCRIPTION OF THE INVENTION

As indicated previously, one aspect of the invention provides a personal hygiene device in the form of a mask 20 comprising a structure that can adopt an erected, operative configuration (FIGS. 2 to 5) and a compacted configuration (FIG. 1). In the compacted configuration, the mask can be accommodated in, for example, a pocket or purse of a user. The structure has a memory that tends to return the structure to its erected configuration when unrestrained (FIGS. 2 to 5). In other words, the mask will quickly “spring open” ready for use when withdrawn from the confines of a pocket, purse or the like.

In the erected configuration shown in FIGS. 2 to 5, the mask covers the mouth and nose of a wearer. As will be described in more detail, the mask is impervious to outward expulsion of material from the mouth and/or nose of the user in coughing or sneezing. At the same time, the mask has an opening 24 that is closed by a filter 26 for allowing release of excess air that results from the sneeze or cough. Typically, the mask opening 24 is of relatively large diameter, for example, about three inches.

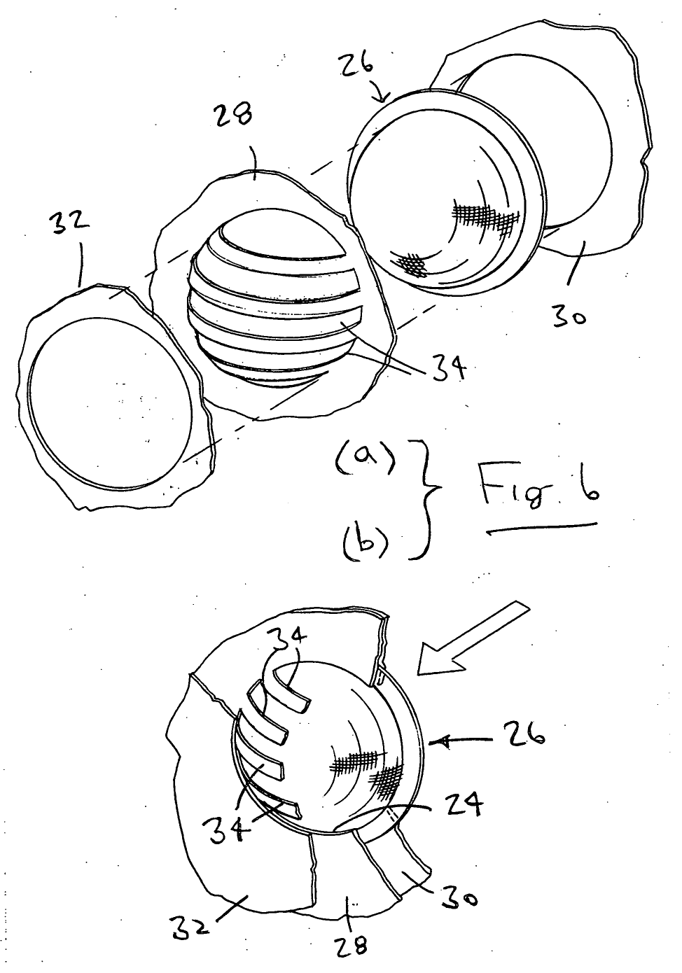

In this particular embodiment, the mask structure includes a plastic moulded core or base which is denoted by reference numeral 28 in FIG. 5. Preferably, the core or base is thermally formed from polypropylene film. The structure also includes inner and outer paper layers 30 and 32 respectively. The inner layer 30 should provide for some liquid absorbency and may be a woven paper material of the type typically used for conventional particle masks. The outer layer 32 is essentially decorative and can be a more dense paper and provided with appropriate decorative material, or colouring. The outer layer 32 could even be a fabric or other material. Conversely, layer 32 could be omitted entirely.

Core 28 is moulded in an appropriate generally conical shape with an outwardly curved marginal portion 28a that is contoured so that the mask fits comfortably and to some extent seals against the face of the wearer. The inner and outer layers 30 and 32 of course follow the contours of the core or base.

The opening 24 in the core or base is shown as circular but this is not essential. In the illustrated embodiment, a series of spaced strips 34 of the polypropylene core material extend across the opening and provide surfaces against which the filter 26 bears so that the strips to some extent prevent the filter being blown out of the mask as a result of a particularly violent cough or sneeze. Obviously, the particular configuration of strips is not essential and may vary, or the strips may be replaced by a grid-like structure or other restraint means.

The filter 26 itself is shaped to match the shape of the opening 24. In the illustrated embodiment, filter 26 has a circular overall configuration and a loosely padded air pervious structure. In general, the overall appearance of the filter may be likened to a circular teabag. The precise structure of the filter may vary. For example, the filter may comprise inner and outer paper layers with a fibrous pad of absorbent material between the layers. The filter is glued or otherwise adhered to the polypropylene core of the mask around the perimeter of the filter and, preferably, along the strips 34.

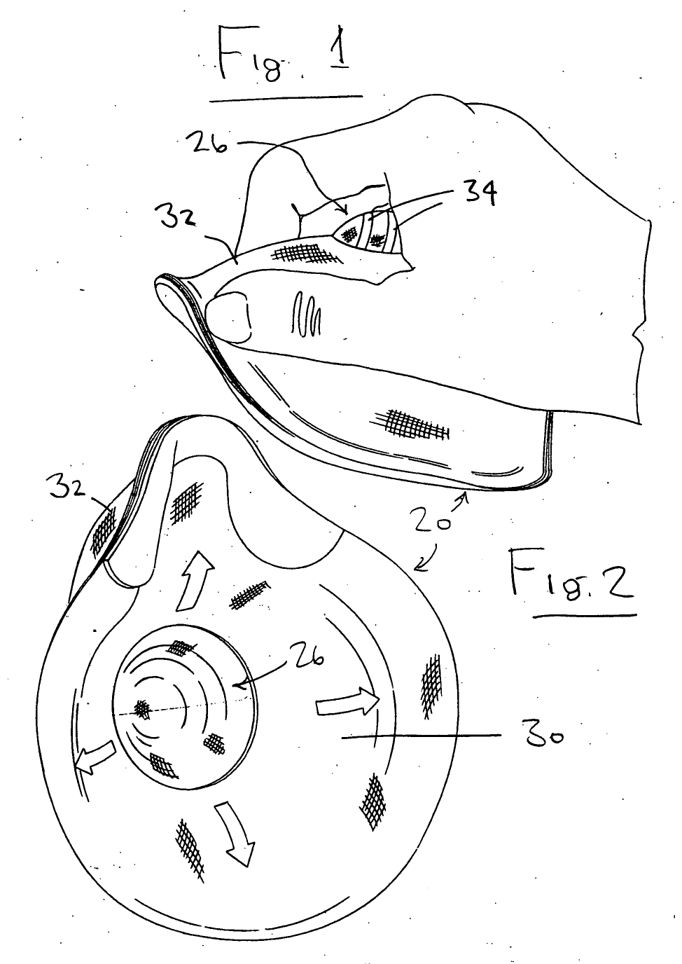

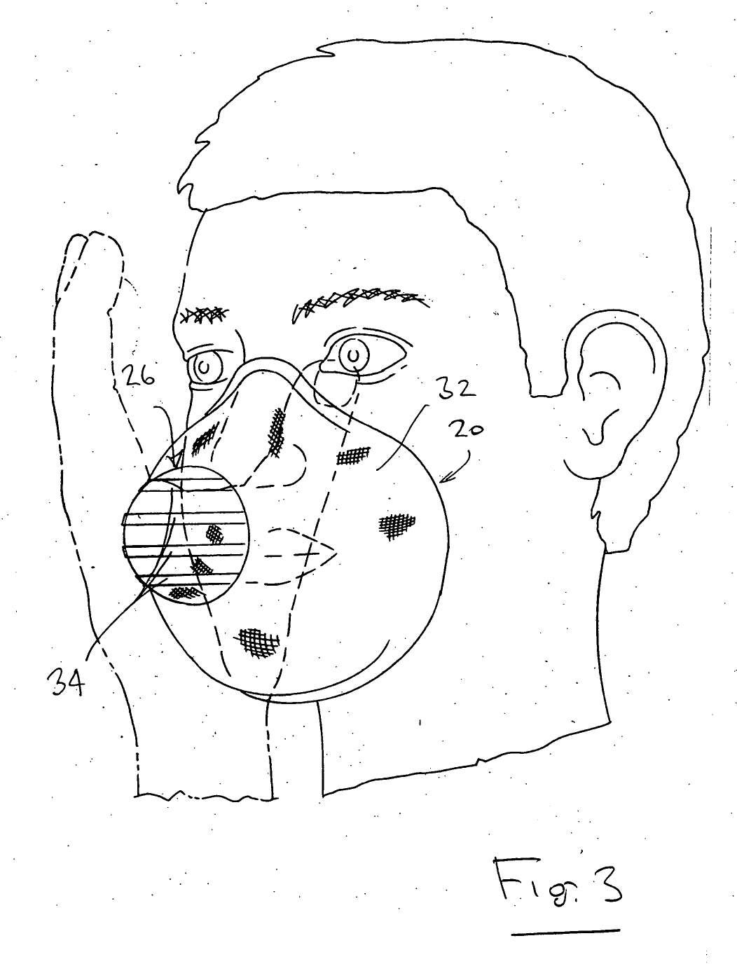

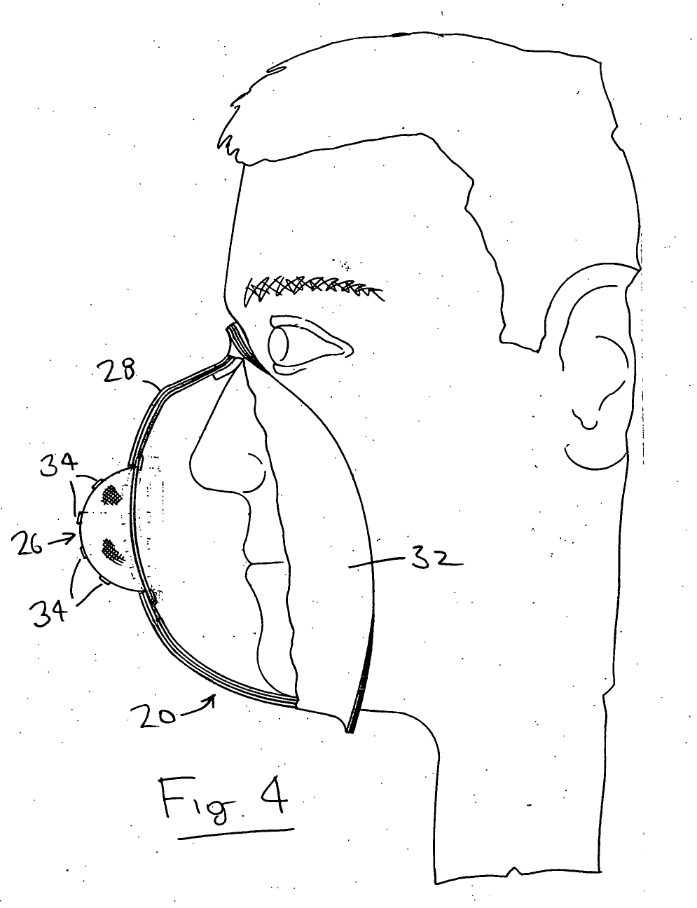

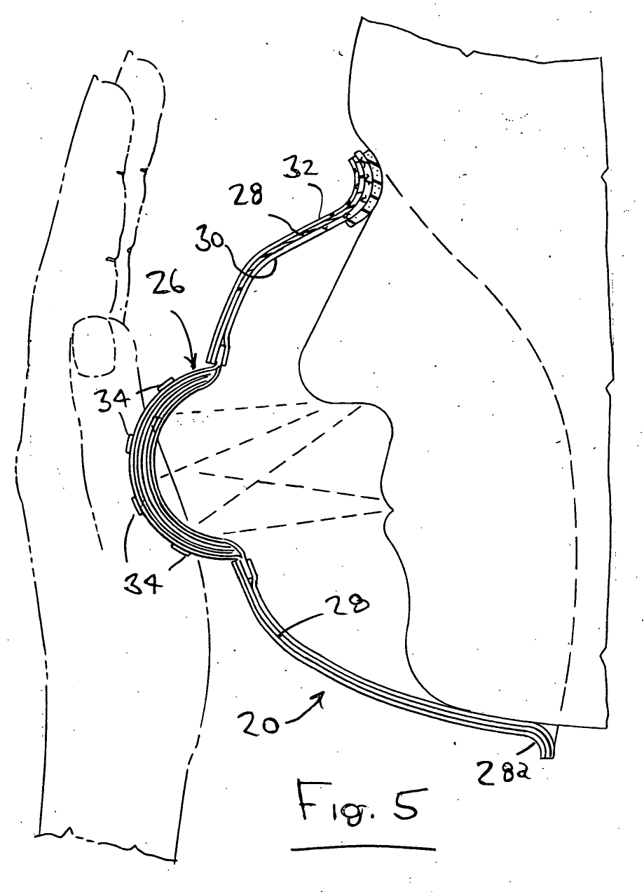

In the particular embodiment illustrated, the strips 34 that restrain the filter 26 are curved outwardly to form a part-spherical dome or bulb-shaped filter “basket” as best seen in FIGS. 4 and 5, and the filter 26 itself is correspondingly shaped, as best seen in FIG. 6. While the filter could be flat or follow the “natural” contour of the main body of the mask, it is believed that the bulb-shaped configuration described is preferred. For example, the strips 34 then form a “pocket” into which the filter 26 fits. The filter will tend to naturally remain in place in the pocket, although it is intended that the filter will still be glued to the strips 34.

It is believed that the provision of a bulb-shaped filter basket also is advantageous in terms of avoiding any resistance to compaction or “crushing” of the mask when the mask is to be placed in the pocket or purse of a user. Further, any obstruction or impediment to movement of air within the mask is minimized. At the same time, the bulb-shaped filter basket will provide a natural convexly curved external shape so that the palm of the user's hand will fit naturally around the mask and hold the mask to the user's face (see FIG. 5).

As noted previously, the core of the mask is preferably made of a polypropylene or polypropylene-based material. In any event, the material should be engineered to have a “no break” rating in accordance with industry standards for plastic mouldings; i.e. the material should not break or crack when the mask is crushed. Preferably, the material has a rating of between 10 and 15 in accordance with the standard “Izod” engineering test for rating the flexibility and breakability of plastic.

In summary, the mask shown in the drawings represents a personal hygiene device for protecting third parties against the spread of germs. The mask may be used in a method in which it is normally kept in a person's pocket or purse in its compacted configuration as shown in FIG. 1. When the user feels a sneeze or cough coming on, the mask is withdrawn and allowed to spring open to its erected configuration. The user then places the mask over the nose and mouth as shown in FIG. 3. The polypropylene base or core of the mask is moisture impervious and will contain material expelled from the nose and/or mouth of the wearer when the sneeze or cough occurs. At the same time, resultant excess air within the mask is released through the filter and the filter itself prevents or at least minimizes any expulsion of material through the mask opening 24.

It will of course be appreciated that the preceding description relates to a particular preferred embodiment of the invention and that many modifications are possible. A number of these modifications have been indicated previously and others will be apparent to a person skilled in the art.

1. A method of preventing or limiting the spread of germs comprising:
providing for wear by an individual, a mask comprising a structure that can is capable of adopting an erected, operative configuration and a compacted configuration and which is crushable to said compacted configuration, the structure having a memory so that it tends to return to its erected configuration when unrestrained, and being shaped to cover the mouth and nose of a wearer when in said erected configuration, the structure being impervious to outward expulsion of material from the mouth and/or nose of a user in sneezing or coughing, while including an opening that is closed by a filter for allowing release of excess air from a sneeze or cough;
crushing the mask to said compacted configuration and retaining the mask in said compacted configuration;
releasing the mask to allow it to adopt its erected configuration when a sneeze or cough is anticipated by a user; and,
holding the mask over the mouth and nose of the user during sneezing or coughing.

2. A personal hygiene device in the form of a mask comprising a structure that can is capable of adopting an erected, operative configuration and a compacted configuration and which is crushable to said compacted configuration, the structure being adapted to normally retain said compacted configuration when constrained and having a memory so that it tends to return to its erected configuration when unrestrained, and being shaped to cover the mouth and nose of a wearer when in said erected configuration, the structure being impervious to outward expulsion of material from the mouth and/or nose of a user in sneezing or coughing, while including an opening that is closed by a filter for allowing release of excess air from a sneeze or cough.

3. A device as claimed in claim 2, wherein the mask structure includes a plastic moulded base or core which is crushable to permit the mask to adopt said compacted configuration and which has a memory normally maintaining the mask in said erected, operative configuration, the base or core including said opening closed by said filter.

4. A device as claimed in claim 3, wherein the plastic base or core has inner and outer surfaces covered with respective layers of paper.

5. A device according to claim 3, wherein the plastic base or core includes structure that extends across the opening for restraining the filter against being blown out of the mask.

6. A device as claimed in claim 2, wherein the opening is circular and the filter comprises a structure resembling a round teabag that is secured around its perimeter to the perimeter of the opening.

7. A device as claimed in claim 3, wherein the plastic material is polypropylene or polypropylene based.

8. A device as claimed in claim 2, wherein the mask includes a surface around its perimeter that is outwardly curved in cross-section to fit against the face of a wearer.

9. A device as claimed in claim 2, wherein said filter has a part-spherical, generally bulb-shaped overall configuration.

10. A device as claimed in claim 5, wherein said structure includes a plurality of strips of said base or core that extend across said opening and are outwardly convexly curved to provide a filter basket of part-spherical or bulb-shaped overall configuration.

11. A device as claimed in claim 3, wherein said plastic base or core is engineered to achieve an Izod rating of between 10 and 15.
